(19) United States
(12) Patent Application Publication
(10) Pub. No.: US 2011/0120957 A1
(43) Pub. Date: May 26, 2011

(54) Method for Treating Liquids

(75) Inventors: Osmon Scipio, Stockholm (SE); Carl Tullstedt, Saltsjo-Boo (SE)

(73) Assignee: Wallenius Water Aktiebolag, Stockholm (SE)

(21) Appl. No.: 11/883,360

(22) PCT Filed: Feb. 2, 2006
(86) PCT No.: PCT/SE06/00145

§ 371 Date: Jan. 28, 2008

(30) Foreign Application Priority Data
Feb. 3, 2005 (SE) 0500255-5

(51) Int. Cl. C02F 1/32

(52) U.S. Cl. 210/748.1; 210/760; 210/193; 422/22; 422/186.3

(57) ABSTRACT

The present invention relates to a method for treating fluids, characterised in the steps of radiating the fluid with UV light, producing and dispersing gas bubbles in the fluid in the rays of the UV light, in order to increase the scattering of the UV light in the liquid. The invention also relates to a device for performing the method.

### TECHNICAL FIELD

The present invention relates to a method for treating liquids, and in particular when utilising light for radiating the liquid to be treated.

### BACKGROUND OF THE INVENTION

For many years light with different wave lengths has been used for treating liquids that are polluted in many ways. The liquids could be water that contains organisms that are harmful to living creatures, like the legionella bacteria that can be found in water pipes and cooling towers, human debris in for example swimming pools and spas, organisms in salt water that the ballast tanks of cargo ships are filled with when they are not loaded with cargo, just to mention a few.

Methods have been developed in several countries for purifying water with ozone (O3) in drinking water installations and bathing facilities, and also ozone dissolved in water for cleaning, disinfection and sterilization of articles. The reaction capacity of ozone (2.07 V electrochemical oxidation potential) is ascribed to the fact that it is a powerful oxidant. The high chemical reactivity is coupled with the unstable electron configuration which seeks electrons from other molecules, which thus means that free radicals are formed. In this process, the ozone molecule is broken down. By means of its oxidizing effect, the ozone acts rapidly on certain inorganic and organic substances. Its oxidizing effect on certain hydrocarbons, saccharides, pesticides, etc., can mean that ozone is a good choice of chemical in certain processes. A combination of ozone, oxygen, hydroperoxide and UV radiation means that the reaction proceeds much more quickly and more efficiently by virtue of the generation of more free radicals. The photolytic and photo-catalytic process is used to decompose the organisms, rendering them harmless, and for that purpose light with different wave lengths are used. One of the common spectras used is UV-light where certain wave lengths are more effective than others in creating the desired effect. For example, wavelengths below 200 nm have a good effect in creating ozone from the oxygen in the liquid, which ozone reacts with the organisms. In order to increase the effect some methods use additional oxygen to promote the creation of ozone.

Another method is to radiate the created ozone with UV light of a certain wave length in order to break down the ozone and create radicals, which are more aggressive than ozone. Such a method is disclosed in EP 0 800 407, in which the medium which is to be treated is introduced into some form of enclosure. In the enclosure, the medium is exposed to UV radiation with a spectral distribution within the range of 130-400 nm. The wavelengths below 200 nm, in particular, convert the oxygen in the medium to ozone molecules (O₃). The ozone molecules formed are at the same time decomposed by radiation within the above-mentioned wavelength range, especially at wavelengths of 200-400 nm. At the same time, the O₂ formed is broken down to form atomic oxygen. In order to increase the efficiency during generation of free radicals, in particular HO′ radicals, catalysts are utilized.

In some areas of use, such as treating seawater having a high salinity level, the above-mentioned methods of creating and breaking down ozone did not work as good as expected because the chloride ions in the saltwater absorbed the UV wave length required for ozone formation. In WO 2004/033376 a solution to this was developed, in which ozone was created outside the purifier and injected into the liquid flow upstream the purifier. It has created good results but means a rather complicated, and thus costly, design of the purifier.

### BRIEF DESCRIPTION OF THE INVENTION

The aim of the present invention is to provide a method for treating fluids with UV radiation having a high degree of treatment capability, which at the same time is uncomplicated regarding construction and operation.

This aim is achieved according to the present invention by the method according to claim 1.

Further preferable features of the invention are found in the dependent claims.

According to a main aspect of the invention it is characterised by a method for treating fluids, characterised in the steps of radiating the fluid with UV light, producing and dispersing gas bubbles in the fluid in the rays of the UV light, in order to increase the scattering of the UV light in the liquid.

The gas bubbles produced should be small, preferably with a diameter in the region 0.01 to 5 mm.

According to another aspect of the invention, a turbulence is caused in the liquid and the liquid is constantly flowing past the UV light.

The UV light comprises at least a wavelength below 200 nm and preferably also wave lengths of 200-400 nm.

The advantages with the present invention are several. Due to the dispersion of the small bubbles in the liquid to be treated an increased efficiency of the UV light in treating the liquid is obtained. This efficiency is further increased by the turbulence created in the liquid, preferably by the bubbles themselves.

In view of the state of the art, the present invention provides a simplified design with fewer parts and less complicated construction, but with a very good performance. In all, a cost effective method for treating liquids is obtained.

The present invention is applicable to all photolytic and photo-catalytic processes from UV light radiation to the method described in EP 0 800 407 where ozone is created in the liquid and then at the same time is broken down to produce free radicals in combination with catalysts. Depending on the application and the rate of pollution in the liquid, more or less auxiliary devices and functions can be added, like adding extra ozone, stirring of the liquid, providing filters, just to mention some.

These and other aspects of, and advantages with, the present invention, will become apparent from the following detailed description and from the accompanying drawings.

### BRIEF DESCRIPTION OF THE DRAWINGS

In the detailed description of the invention, reference will be made to the accompanying drawings, of which

FIG. 1 is a schematic cross-sectional view of a device for performing the method according to the present invention.

### DETAILED DESCRIPTION OF THE INVENTION

When treating liquids such as water with UV light, it is a well known fact that UV energy is absorbed by water and that the UV intensity decreases with the distance from the light source.

The main aim of the present invention is to reduce these adverse effects. According to a main principle of the present invention, gas bubbles are produced and dispersed in the liquid in the path of the UV light rays.

In experiments a relatively large improvement in algae mortality has been observed with the introduction of small gas bubbles in the path of the UV light rays, when tested on seawater.

UV energy is absorbed by water and the UV-intensity decreases with increasing distance from the UV light source. When air bubbles are introduced in the water the situation changes somewhat.

The average absorption decreases, since the air inside the bubbles is absorbing less light. On the other hand, the air bubbles introduce light scattering, and the ray path in the water will be more zigzag like. This increases the path in water for reaching outer regions, and the effective light absorption will be high.

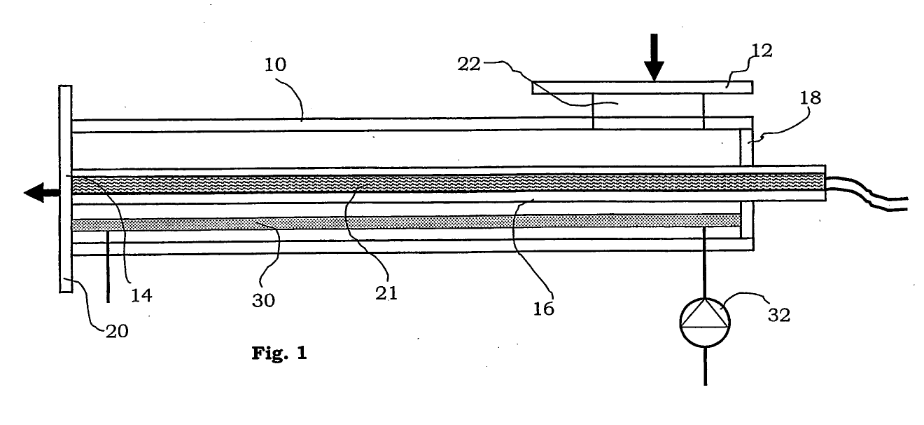

Tests have been performed with a purifier according to FIG. 1. The purifier comprises a treatment container 10 having an inlet 12 and an outlet 14 connectable to a transport system for the liquid to be treated. The inner surface contains a photocatalytic surface of TiO₂. The titanium also has the advantage that it is very resistant to the corrosive environment inside the container.

A tube 16 made of quartz glass extends through the interior of the container between two opposite walls 18, 20. Inside the quartz tube a UV radiating light source 21 is arranged, which extends between the opposite walls of the compartment. The light source is connected to a suitable power supply. The UV radiating light source is chosen such that it emits wave lengths in the region of 130-400 nm, and in particular a wavelength of below 200 nm for converting oxygen in the medium to ozone molecules (O₃) and wavelengths of 200-400 nm for decomposing the ozone molecules.

During these tests it has been found that the power gain with 1 mm diameter bubbles, 10% air and 90% water at high transmission is about 30%, with some correction due to shorter exposure time in the purifier (10% air increases water speed). The total power gain is an increase of about 18%. With even smaller bubbles, the results get even better. The average total power gain is 34%. In the regions close to the quartz tube the power gain is almost four times higher compared to bubble-free water. The energy in the outer regions decreases dramatically.

The reason that small bubbles will result in better effect than large bubbles, is that the probability for the light to hit a small bubble is higher than to hit a large bubble. The cross section area exposed to the light is larger with small bubbles. Small bubbles will give a larger section area than large bubbles at the same total volume. This can easily be proved with physical mathematical models.

The reason for increased efficiency depends on a combination of local energy gain, total gain, and turbulence caused by the bubbles.

The bubbles are in a fluent moving quite rapidly over the cross section area which allows for macro size movements. This will highly increase the mixing of the fluid which is the main reason why turbulence is required.

In order to create the desired size of the bubbles, the amount and turbulence of the bubbles, a suitable design of air nozzle 30 is arranged inside the purifier, connected to an air-generating source 32. Preferably the air-generating source and the nozzle are designed and operate such that the dispersed bubbles cause a turbulence in the liquid. It is however to be understood that turbulence could be created, or increased, by other means.

It is further conceivable to increase the amount of ozone by injecting ozone upstream of the purifier, thereby increasing the performance of the purifier, such as is disclosed in WO 2004/033376, by the same applicant as for the present invention.

Even though air is a preferred gas in the bubbles, when looking at cost aspects, it is understood that other gases may be used, depending on the desired function and possible reactions with the liquids to be treated.

It is to be understood that the embodiment of the invention described above and shown in the drawings is to be regarded as a non-limiting example of the invention and that it may be modified in many ways within the scope of the patent claims.

1. Method for treating fluids, characterised in the steps of:
radiating the fluid with UV light,
producing and dispersing gas bubbles in the fluid in the rays of the UV light, in order to increase the scattering of the UV light in the liquid.

2. Method according to claim 1, characterized in producing small gas bubbles.

3. Method according to claim 2, characterized in that the diameter of the bubbles are in the region 0.01 to 5 mm.

4. Method according to claim 1, characterized in causing a turbulence in the liquid.

5. Method according to claim 1, characterized in flowing the liquid past the UV light.

6. Method according to claim 5, characterised in the further step of injecting ozone in the liquid upstream of the UV light.

7. Method according to claim 1, characterized in that the UV light comprises a wavelength of <200 nm.

8. Method according to claim 1, characterized in that the UV light comprises wavelengths of 200-400 nm.

9. Method according to claim 1, characterized in radiating the UV light on catalysts.

10. Method according to claim 9, characterized in that the catalysts comprise titanium oxide.

11. Device for treating fluids, characterised by means capable of radiating the fluid with UV light, and means capable of producing and dispersing gas bubbles in the fluid in the rays of the UV light, in order to increase the scattering of the UV light in the liquid.

12. Device according to claim 11, characterized by means capable of causing a turbulence in the liquid.

13. Method according to claim 2, characterized in causing a turbulence in the liquid.
